(19) United States
(12) Patent Application Publication
(10) Pub. No.: US 2024/0220762 A1
(43) Pub. Date: Jul. 4, 2024

(54) SYSTEMS AND METHODS FOR CROSS POLLINATION INTENT DETERMINATION

(71) Applicant: Walmart Apollo, LLC, Bentonville, AR (US)

(72) Inventors: Ali Arsalan Yaqoob, Union City, CA (US); Yue Xu, San Francisco, CA (US); Hyun Duk Cho, San Francisco, CA (US); Sushant Kumar, San Jose, CA (US); Kannan Achan, Saratoga, CA (US)

(21) Appl. No.: 18/148,261

(22) Filed: Dec. 29, 2022

(51) Int. Cl. G06N 3/006; G06N 3/063

(52) U.S. Cl. CPC G06N 3/006; G06N 3/063

(57) ABSTRACT

Systems and methods of generating an interface including cross-pollinated interface elements are disclosed. A request for an interface for a first intent is received. The request includes a user identifier. An interface generation engine generates an interface including first items associated with the first intent and cross-pollinated items associated with a second intent. The set of cross-pollinated items are selected based on a cross-pollination score. The interface generation engine inserts the items into the interface and transmits the interface to a user device associated with the user identifier. A cross-pollination engine generates the cross-pollination score using a trained sequential prediction model configured to receive the set of features associated with the user identifier and output the cross-pollination score. The cross-pollination score represents a likelihood of a user associated with the user identifier interacting with at least one cross-pollinated item.

### TECHNICAL FIELD

This application relates generally to cross-pollination, and more particularly, to cross-pollination of interface elements.

### BACKGROUND

Network interfaces can include multiple sections or portions devoted to certain interactions with the network interface. For example, an e-commerce interface can include a first portion dedicated to a first type of goods, such as merchandise, and a second portion dedicated to a second type of goods, such as grocery. Interface elements for each portion are segregated and used in interface generation only when the network interface is configured for the specific section related to the elements.

When interacting with an interface, a user may be focused on interactions with a single section (e.g., a single intent) while remaining unaware of elements or items in other sections that may be of interest. Current network interfaces fail to capture opportunities for providing awareness of interface elements and items in other portions of the interface.

### SUMMARY

In various embodiments, a system including a non-transitory memory, a communications interface, an interface generation engine, and a cross-pollination prediction engine is disclosed. The communications interface is configured to receive a request for an interface for a first intent. The request includes a user identifier that is stored in the non-transitory memory. The interface generation engine is configured to generate an interface including a set of first items associated with the first intent, generate a set of cross-pollinated items associated with a second intent, insert the set of cross-pollinated items into the interface, and transmit the interface to a user device associated with the user identifier. The set of cross-pollinated items are selected based on a cross-pollination score. A cross-pollination engine is configured to receive a set of features associated with the user identifier and the first intent and generate the cross-pollination score using a trained sequential prediction model. The trained sequential prediction model is configured to receive the set of features associated with the user identifier and output the cross-pollination score. The cross-pollination score represents a likelihood of a user associated with the user identifier interacting with at least one cross-pollinated item.

In various embodiments, a computer-implemented method is disclosed. The method includes a step of receiving, via a communications interface, a request for an interface for a first intent. The request includes a user identifier that is stored in a non-transitory memory. The method further includes the steps of generating, by an interface generation engine, an interface including a set of first items associated with the first intent, receiving, by a cross-pollination engine, a set of features associated with the user identifier and the first intent, and generating, by the cross-pollination engine, a cross-pollination score using a trained sequential prediction model. The trained sequential prediction model is configured to receive the set of features associated with the user identifier and output the cross-pollination score. The cross-pollination score represents a likelihood of a user associated with the user identifier interacting with at least one cross-pollinated item. The method further includes a step of inserting, by the interface generation engine, a set of cross-pollinated items into the interface. The cross-pollinated items are associated with a second intent. The set of cross-pollinated items are selected based on the cross-pollination score. The method further includes a step of transmitting, via the communications interface, the interface to a user device associated with the user identifier.

In various embodiments, a method of training a sequential prediction model is disclosed. The method includes steps of receiving a set of training data including a plurality of feature sets associated with a plurality of user identifiers, iteratively modifying one or more parameters of a sequential prediction model to minimize a predetermined cost function, and outputting a trained sequence prediction model configured to receive a current a plurality of features related to a user identifier and generate a cross-pollination score. Each feature set in the plurality of feature sets is associated with prior interactions between a user associated with the user identifier and a network interface.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide cross-pollinated interfaces, in accordance with some embodiments.

FIG. 3 illustrates an artificial neural network, in accordance with some embodiments.

FIG. 4 illustrates a tree-based neural network, in accordance with some embodiments.

FIG. 5 is a flowchart illustrating a method of generating an interface including cross-pollinated intents, in accordance with some embodiments.

FIG. 6 is a process flow illustrating various steps of the method of generating an interface including cross-pollinated intents of FIG. 5, in accordance with some embodiments.

FIG. 7 illustrates a partial system diagram for a sequential prediction engine, in accordance with some embodiments.

FIG. 8 illustrates a method for generating a trained state prediction model, in accordance with some embodiments.

FIG. 9 is a process flow illustrating various steps of the method of generating a trained state prediction model of FIG. 8, in accordance with some embodiments.

FIG. 10 illustrates a data layer process flow for a trained state prediction model, in accordance with some embodiments.

FIG. 11 illustrates an interface generation process flow including insertion of elements selected by a next best state prediction method, in accordance with some embodiments.

FIG. 12 illustrates an interface including a carousel having cross-pollinated items, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for generating cross-pollinated network interfaces based on a cross-pollination score generated by a sequential prediction engine. In various embodiment, a sequential prediction engine is configured to receive a set of sequence inputs representative of a one or more past user interactions with an interface and a set of feature inputs related to the sequence unit. The sequential prediction engine is configured to generate a cross-pollination score representative of a percentage of an interface to be provided to cross-pollinated items. The sequential prediction engine generates a score on predicted next states for a user given presentation of cross-pollinated items to determine a likelihood of cross-pollination interaction and, therefore, a percentage of an interface to devote to cross-pollination items.

In some embodiments, a sequential prediction engine includes one or more trained sequential prediction models configured to generate next state predictions based on a sequence input and a set of input features. For example, in some embodiments, one or more sequential prediction models are configured to receive a sequence unit, Sᵢ, representative of a time step state, and set of features Fᵢ that are related to and/or associated with the sequence unit at the current time step state.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a system including one or more neural networks trained (e.g., configured or adapted) to generate cross-pollination scores or intents, is disclosed. A neural network trained to generate cross-pollination scores/intents can be referred to as a trained sequential prediction network and/or a trained sequential prediction model. A trained sequential prediction model can be configured to generate one or more state predictions for a next likely user state, in accordance with some embodiments. In some embodiments, the predicted states relate to likelihood of a user interacting with cross-pollinated interface elements. The predicted states can include user intents and/or specific interface elements (such as items). Although embodiments are discussed herein in the context of an e-commerce environment, it will be appreciated that the disclosed systems and methods can be utilized to predict cross-pollination interface elements for any suitable network environment.

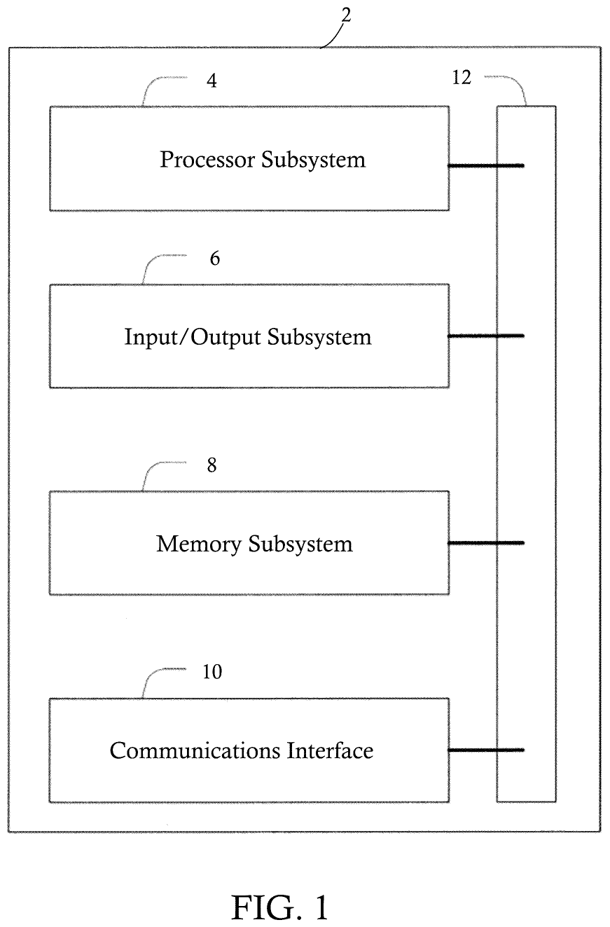

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for generating a network interface including one or more cross-pollinated interface elements based on a cross-pollination score, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

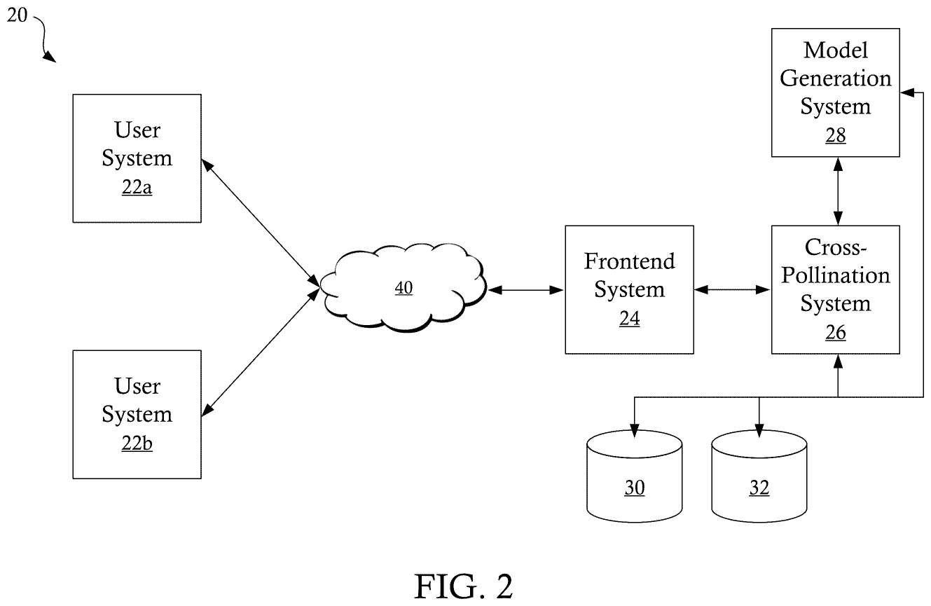

FIG. 2 illustrates a network environment 20 configured to provide a network interface including cross-pollinated interface elements selected based on a model-generated cross-pollination score, in accordance with some embodiments. The network environment 20 includes a plurality of systems configured to communicate over one or more network channels, illustrated as network cloud 40. For example, in various embodiments, the network environment 20 can include, but is not limited to, one or more user devices 22a-22b in signal communication with a frontend system 24. The frontend system 24 can be configured to provide a customized interface, including one or more cross-pollinated interface elements, to each of the one or more user systems 22a-22b.

As used herein, the term “interface elements” can refer to any suitable element inserted into an interface that is configured to provide an interface interaction option to a user. Interface elements can include, but are not limited to, items selected from a catalog associated with the interface, such as a product catalog associated with an e-commerce interface. The items presented on the network interface can enable one or more interface operations, such as, for example, an add-to-cart, a view, a purchase, and/or any other suitable interface interaction.

The customized interface can include any suitable interface. For example, in some embodiments, the customized interface can include an e-commerce interface, a service interface, an intranet interface, and/or any other suitable user interface. In some embodiments, the customized interface includes a webpage, web portal, intranet page, and/or other interactive page generated by the frontend system 24. In some embodiments, the customized interface includes one or more interface elements selected based on a cross-pollination score generated by a sequential prediction engine. The sequential prediction engine can be implemented by any suitable system, such as, for example, a sequential prediction system 26.

In some embodiments, a cross-pollination system 26 implements a cross-pollination prediction engine configured to generate a cross-pollination score. The cross-pollination prediction engine is configured to capture historical user preferences to predict the likelihood of a user interacting with cross-pollinated interface elements in a network interface. In some embodiments, the likelihood of interaction is represented by a cross-pollination score. In some embodiments, a system, such as the frontend system 24 and/or the cross-pollination prediction system 26, is configured to convert the cross-pollination score into a percentage portion of a network interface configured to receive cross-pollinated interface elements. For example, in some embodiments, a higher cross-pollination score indicates a higher likelihood of a user interacting with cross-pollinated interface elements resulting in a larger portion of a generated network interface page being provided for cross-pollinated interface elements. Conversely, in some embodiments, a lower cross-pollination score indicates a lower likelihood of the user interacting with cross-pollinated interface elements, resulting in a smaller (or potential no) percentage of the network interface page being provided for cross-pollinated interface elements.

In some embodiments, the cross-pollination prediction engine includes one or more sequential models configured to generate cross-pollination scores. For example, a cross-pollination model can be configured to receive a set of inputs including a set of prior interactions and a set of features. The set of features can include any suitable set of features related to the prior interactions with the user interface. For example, the set of features can include, but is not limited to, meta features associated with a sequence at a time step. Each of the cross-pollination models can include a predetermined framework trained using a set of features related to the state prediction. For example, in various embodiments, each of the cross-pollination models can be configured to implement a self-attentive sequential recommendation (SASRec) framework, a Time-aware self-attentive sequential recommendation (TiSASRec) framework, and/or any other suitable framework. In some embodiments, the predicted likelihood of transitioning to a cross-pollinated state is provided as a cross-pollination score.

In some embodiments, the cross-pollination prediction system 26 is in communication with one or more databases 30. The database 30 can be configured to store sets of features related to determining a cross-pollination score. For example, in various embodiments, one or more databases 30 can be configured to store feature sets related to prior interactions, user features, and/or any other suitable features for generating a cross-pollination score. The databases 30 can further be configured to store one or more trained cross-pollination models for execution by a cross-pollination prediction engine and/or assets (e.g., templates, content elements, etc.) for inclusion in a generated user interface.

In some embodiments, the network environment 20 includes a model training system 28 configured to generate one or more cross-pollination models. The model training system 28 can be configured to implement an iterative training process, as discussed in greater detail below, to generate the cross-pollination model(s). In some embodiments, the model training system 28 is configured to generate cross-pollination models configured to provide a cross-pollination score. The one or more generated cross-pollination models can be provided to a cross-pollination prediction system 26 for implementation, e.g., generation of a cross-pollination score as part of an interface generation process.

In some embodiments, the model training system 28 is configured to obtain training data sets, such as sets of prior interactions and/or sets of features associated with one or more prior interactions, from a database 32. In some embodiments, the model training system 28 is configured to receive one or more identifiers, such as a user identifier or sequence identifier, as part of training data set. Each of the identifiers can be used to retrieve a set of features and/or a sequence set (e.g., set of prior interactions) associated with the identifier.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

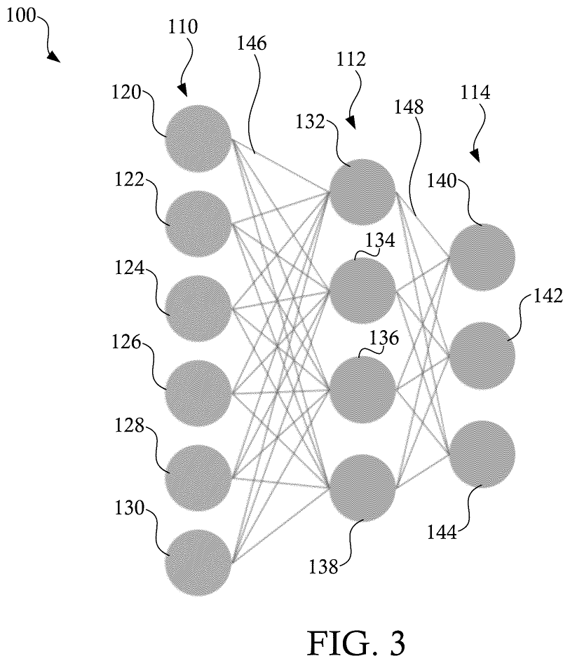

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1] or within the interval [0, 1]. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{{′}^{( n )}} = {w}_{i , j}^{( n )} - γ \cdot {δ}_{j}^{( n )} \cdot {n}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

In some embodiments, the neural network 100 is configured, or trained, to generate a likelihood of interacting with a cross-pollinated interface element given a prior sequence set (e.g., prior interactions) and/or a feature set associated with prior interactions. The neural network 100 is configured to output a cross-pollination score. In some embodiments, the cross-pollination score determines a percentage of a customized interface devoted to cross-pollinated interface elements.

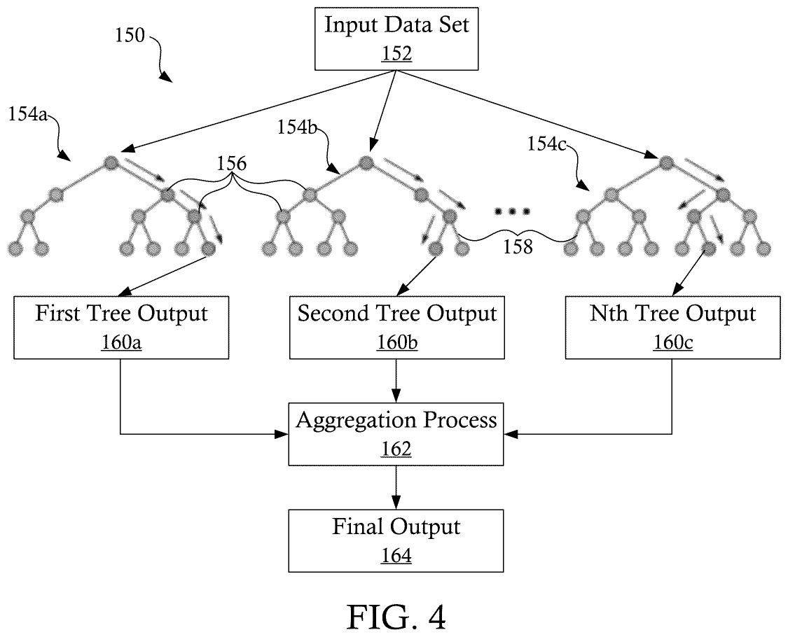

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

In some embodiments, the tree-based neural network 150 is configured, or trained, to generate a likelihood of interacting with a cross-pollinated interface element given a prior sequence set (e.g., prior interactions) and/or a feature set associated with prior interactions. The tree-based neural network 150 is configured to output a cross-pollination score. In some embodiments, the cross-pollination score determines a percentage of a customized interface devoted to cross-pollinated interface elements.

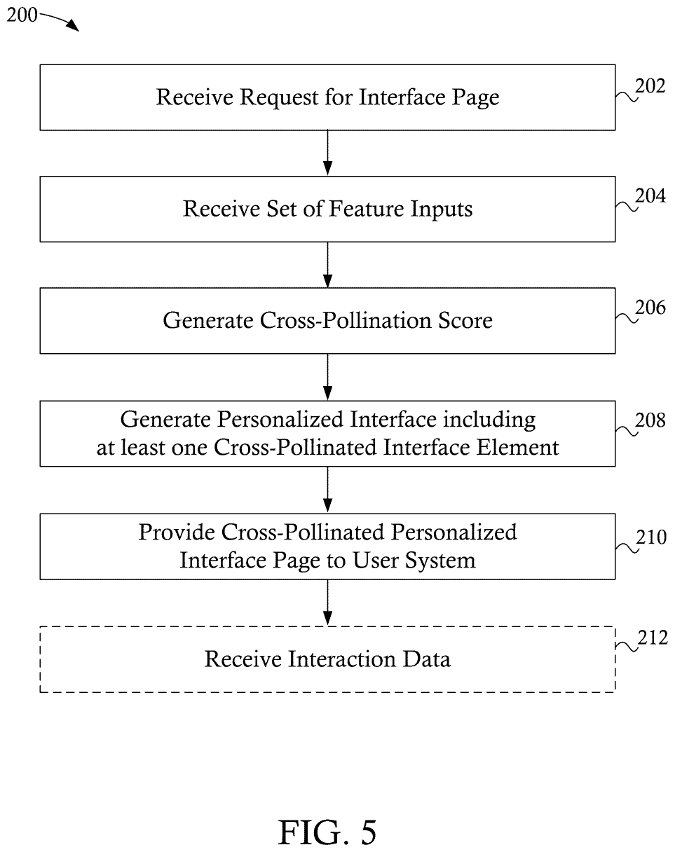

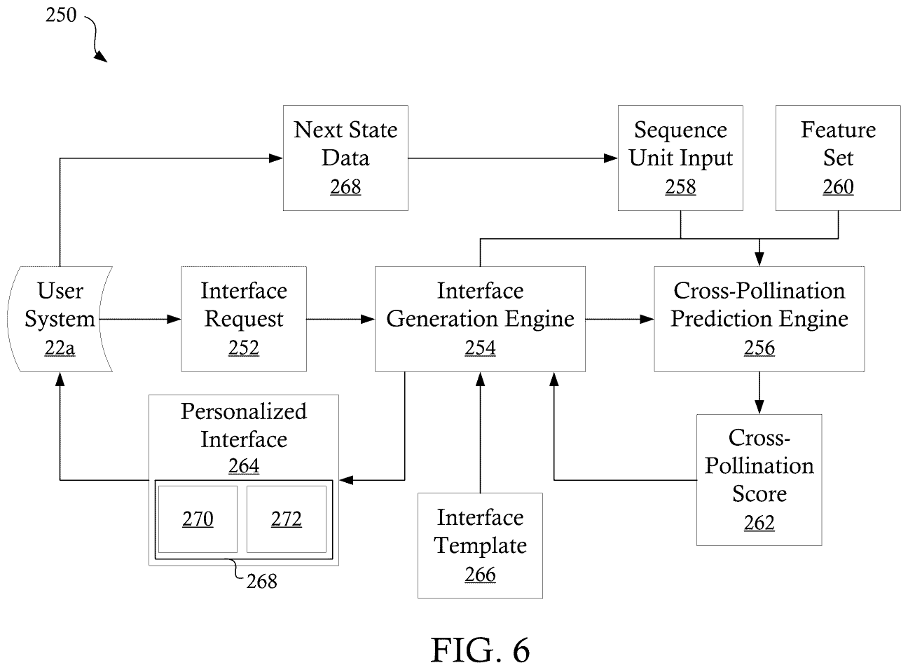

FIG. 5 is a flowchart illustrating a method 200 of generating a network interface including one or more cross-pollinated interface elements, in accordance with some embodiments. FIG. 6 is a process flow 250 illustrating various steps of the method 200 of generating a network interface including cross-pollinated interface elements, in accordance with some embodiments. At step 202, a request 252 for an interface page can be received by any suitable system or engine, such as, for example, an interface generation engine 254. The request for the interface can be received from any suitable system, such as, for example, a user system 22a, 22b. The request can include one or more data elements identifying a user or profile associated with the requests and/or can include data elements identifying a prior sequence of states for user interactions with the network interface. For example, in various embodiments, a request can include data elements such as cookies and/or beacons. In some embodiments, one or more data elements can be retrieved from a database based on the request.

At step 204, a cross-pollination prediction engine 256 receives a sequence unit input 258 and a feature set 260. The sequence unit input 258 can be included as part of the request 252 and/or obtained from a database based on one or more identifiers. For example, in some embodiments, a request 252 for an interface includes a user identifier associated with user interactions with a network interface. When the interface generation engine 254 receives the request 252 for an interface, the interface generation engine 254 can obtain user sequence data from a database. Similarly, an interface request can include a feature set 260 associated with the sequence unit input 258 and/or a feature set 260 can be obtained from a database based on an identifier, such as a user identifier and/or a sequence unit identifier. The sequence unit input 258 and/or the feature set 260 can be provided to the cross-pollination prediction engine 256 directly from the user system 22a, from the interface generation engine 254, loaded from a database, and/or otherwise acquired by the cross-pollination prediction engine 256.

In some embodiments, the cross-pollination prediction engine 256 is configured to receive a feature set 260 including one or more user features representative of user interactions with an interface, such as user interactions with prior states and/or elements presented in prior interactions with an interface generated by the frontend system 24. User features can include, but are not limited to, the number of transactions feature (e.g., a feature representative of a number of transactions performed by a user in a predetermined time period (e.g., per month, per week, etc.)), a user affinity feature (e.g., a feature representative of a user affinity for portions of an interface such as grocery portion or a general merchandise portion of an e-commerce interface), a context affinity feature (e.g., a feature representative of a user affinity for a specific interface context), an inter-purchase interval feature (e.g., a feature representative of time between transactions), an items viewed feature (e.g., a feature representative of a number of items viewed in a predetermined time period or frequency of items viewed in a predetermined time period), an add-to-cart feature (e.g., a feature representative of a number of items added to a cart in a predetermined time period), a fulfillment intent feature (e.g., a feature representative of a fulfillment intent (e.g., pickup, delivery, etc.) for an order), and/or other suitable user-preference features. In some embodiments, the user-preference features are representative of a user understanding that includes, for example, user-level preference features such as a brand preference feature, a price preference feature, an intent feature (e.g., purchase intent, sell intent, etc.), and/or any other suitable user-level preference features.

At step 206, the cross-pollination prediction engine 256 generates a cross-pollination score 262. The cross-pollination score 262 represents a likelihood of a user interacting with cross-pollinated interface elements of a second intent on a network interface configured for a first intent. In some embodiments, the cross-pollination prediction engine 256 includes one or more cross-pollination prediction models configured to generate a likelihood of a transition to at least one intent. The likelihood of transition can be output as a cross-pollination score 262.

In some embodiments, the cross-pollination prediction engine 256 receives a sequence unit input 258 including user historical data. For example, in some embodiments, a cross-pollination prediction model can be configured to receive a user's prior interactions with a network interface, including one or more prior transactions, add-to-cart actions, item views, etc., item features for prior item interactions such as item labels (e.g., intent labels), item product type embeddings, a user consideration intent (e.g., the current intent vs. cross-pollinated intent for a user), and/or any other suitable input features.

In some embodiments, the cross-pollination prediction engine 256 includes one or more cross-pollination prediction models having an implemented sequential framework. For example, in some embodiments, one or more cross-pollination prediction models can include a SASRec or TiSASRec framework. Although specific embodiments are discussed herein, it will be appreciated that any suitable recommendation framework, such as a sequential recommendation framework, stochastic recommendation framework, etc., including a self-attentive element can be configured to provide a cross-pollination prediction. The cross-pollination prediction of the sequential framework can be output as a cross-pollination score 262.

At step 208, the cross-pollination score 262 is provided to the interface generation engine 254 to generate a personalized interface. The interface generation engine 254 is configured to generate at least one personalized (e.g., user-specific/customized) interface page 264. The personalized interface page 264 can include one or more cross-pollinated interface elements 272. The number of cross-pollinated interface elements 272 depends, at least in part, on the cross-pollination score. In some embodiments, the number of cross-pollinated interface elements 272 included in the personalized interface page 264 can be determined by (or based on) the cross-pollination score 262.

In some embodiments, the interface generation engine 254 is configured to obtain an interface template 266 and populate the interface template 266 with one or more interface containers 268 and/or interface elements 270 to generate a personalized interface page 264. One or more cross-pollinated interface elements 272 can be selected based on a cross-pollination score 262 for inclusion in the personalized interface page 264.

In some embodiments, the interface generation engine 254 is configured to implement a whole interface personalization process. An interface template 266 can be selected and populated with interface containers 268 configured to receive one or more interface elements 270 primarily related to a first user intent. Elements related to the first intent can be selected using any suitable process and positioned within predetermined portions of the interface template 266. During the interface personalization process, the interface generation engine 254 receives a cross-pollination score 262 from the cross-pollination prediction engine 256. In some embodiments, the cross-pollination score 262 represents a likelihood of a user interacting with one or more interface elements selected from a second intent.

One or more cross-pollinated interface elements 272 can be selected based on a cross-pollination score 262 for inclusion in the personalized interface page 264. The cross-pollination score 262 can be compared to one or more thresholds to determine the number of cross-pollinated interface elements 272 to be included in the interface. As one example, in some embodiments, if the cross-pollination score 262 is below a first predetermined threshold, the personalized interface page 264 includes no cross-pollinated interface elements 272, as the cross-pollination score 262 indicates that cross-pollination is unlikely to be effective; if the cross-pollination score 262 is equal to or greater than the first predetermined threshold but less than a second predetermined threshold, the personalized interface page 264 can include a first number of cross-pollinated interface elements 272, such as one cross-pollinated interface element 272; and if the cross-pollination score 262 is equal to or greater than the second predetermined threshold, the personalized interface page 264 can include a second number of cross-pollinated interface elements 272, such as 2 or more cross-pollinated interface elements 272. Although specific examples are provided herein, it will be appreciated that the interface generation engine 254 can be configured to insert any number of cross-pollinated interface elements 272 based on the value of the cross-pollination score 262.

In some embodiments, the cross-pollinated interface elements 272 are incorporated into one or more interface containers 268 configured to provide interface elements 270 related to the first intent. For example, if a request 252 is related to an interface page for a first intent, such as a grocery intent, the interface generation engine 254 can generate a personalized interface page 264 based on an interface template 266 populated with interface containers 268 configured to hold one or more interface elements 270 related to the first intent, e.g., the grocery intent. The cross-pollination score 262 for the user associated with the request 252 can indicate a likelihood of interactions with interface elements related to a second intent, for example, a general merchandise intent. As described herein, the likelihood of a user interacting with an interface element related to a second intent, e.g., a cross-pollinated interface element, can be determined by a cross-pollination prediction model. A number of cross-pollinated interface elements 272, for example, two cross-pollinated interface elements 272, can be inserted into an interface container 268 in place of and/or in addition to the interface elements 270. The number of cross-pollinated interface elements 272 can be based on a comparison of the cross-pollination score 262 to one or more predetermined thresholds.

At step 210, the personalized interface page 264 (e.g., a response to the request 252 including the personalized interface page 264) is provided to the user system 22a, 22b that initially transmitted the request 252. At optional step 212, interaction data 274 is received, for example, from the user system 22a, 22b. The interaction data 274 represents interactions for the personalized interface page 264. For example, the interaction data 274 can indicate that interactions with (or a lack of interactions with) cross-pollinated interface elements 272. The received interaction data 274 can be used to train (or retrain) one or more sequential prediction models.

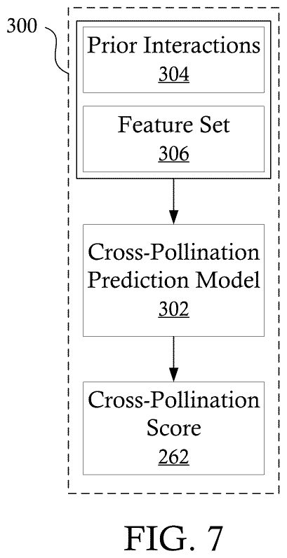

FIG. 7 illustrates a partial system diagram for a cross-pollination prediction engine 300 configured to generate a cross-pollination score 262, in accordance with some embodiments. In some embodiments, the cross-pollination prediction engine includes a cross-pollination prediction model 302 configured to generate cross-pollination scores 262. The cross-pollination prediction model 302 can include a trained sequential model configured to receive a set of inputs including a set of prior interactions 304 and a set of features 306. The set of features 306 can include any suitable set of features related to the prior interactions with the user interface. For example, the set of features 306 can include, but is not limited to, meta features associated with a sequence at a time step, user preferences, historical user data such as historical transaction data, historical add-to-cart data, historical item view data, item features such as item labels (e.g., intent labels), item product type embeddings, user intent, and/or any other suitable input features. Each of the sequential models can include a predetermined framework trained using a set of features related to the cross-pollination prediction. For example, in various embodiments, each of the sequential models can be configured to implement a self-attentive sequential recommendation (SASRec) framework, a Time-aware self-attentive sequential recommendation (TiSASRec) framework, and/or any other suitable framework. In some embodiments, a predicted likelihood of transitioning to a cross-pollination state generated by the sequential model is provided as a cross-pollination score 262 output.

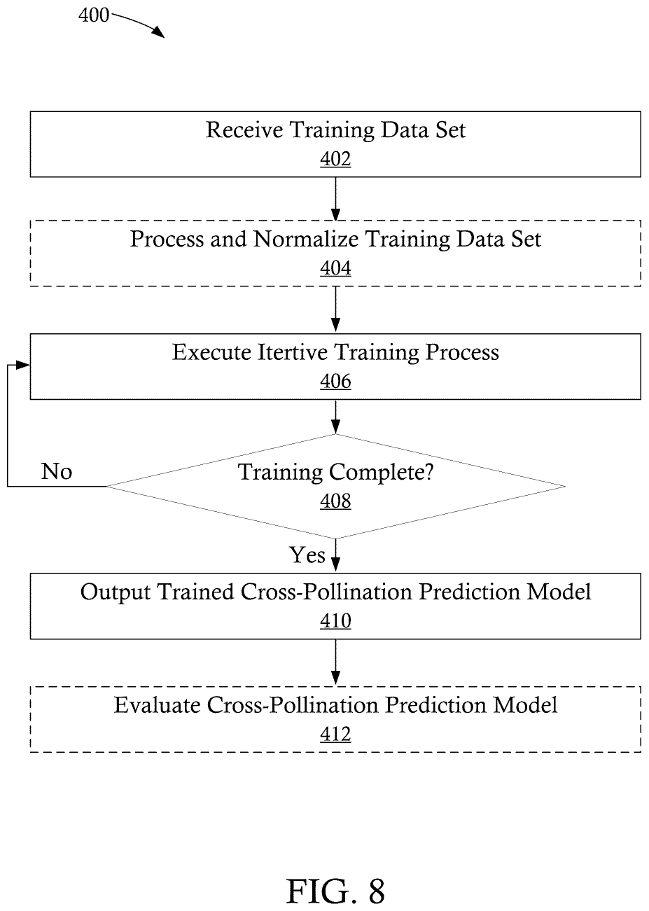

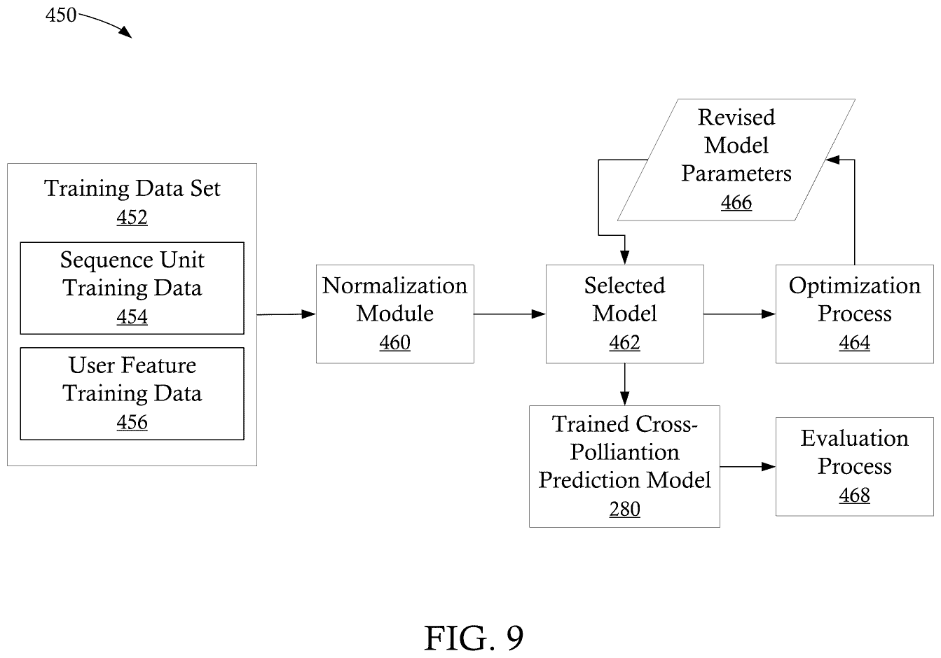

In some embodiments, a trained cross-pollination prediction model is generated using an iterative training process based on a training data set. FIG. 8 illustrates a method 400 for generating a trained cross-pollination prediction model in accordance with some embodiments. FIG. 9 is a process flow 450 illustrating various steps of the method 400 of generating a trained cross-pollination prediction model, in accordance with some embodiments. At step 402, a training data set 452 is received by a system, such as model training system 28. The training data set 452 can include labeled and/or unlabeled data, depending on the type of model and/or the type of training process being implemented. For example, when a supervised learning process is applied to train a SASRec or TiSASRec framework, the training data set 452 can include labeled data.

In some embodiments, the training data set 452 includes historical interaction data, such as historical sequence unit training data 454. The sequence unit training data 454 can include data representative of sequential state changes for one or more users for prior interactions with a user interface, such as sequential state changes related to transitions through interface pages within a network interface, transitions for viewing, adding, or otherwise interacting with e-commerce items, etc. Sequential state changes can include a single state transition, i.e., a transition from a prior state to a next state, and/or can include a sequence of state changes, i.e., transitions from an initial state to a final state including one or more intermediate states.

In some embodiments, the training data set 452 includes user feature training data 456. The user feature training data 456 can include one or more user features representative of user interactions with an interface, such as user interactions with prior states and/or elements presented in prior interactions with an interface generated by the frontend system 24. User features can include, but are not limited to, the number of transactions feature (e.g., a feature representative of a number of transactions performed by a user in a predetermined time period (e.g., per month, per week, etc.)), a user affinity feature (e.g., a feature representative of a user affinity for portions of an interface such as grocery portion or a general merchandise portion of an e-commerce interface), a context affinity feature (e.g., a feature representative of a user affinity for a specific interface context), an inter-purchase interval feature (e.g., a feature representative of time between transactions), an items viewed feature (e.g., a feature representative of a number of items viewed in a predetermined time period or frequency of items viewed in a predetermined time period), an add-to-cart feature (e.g., a feature representative of a number of items added to a cart in a predetermined time period), a fulfillment intent feature (e.g., a feature representative of a fulfillment intent (e.g., pickup, delivery, etc.) for an order), and/or other suitable user-preference features. In some embodiments, the user features are representative of a user understanding that includes, for example, user-level preference features such as a brand preference feature, a price preference feature, an intent feature (e.g., purchase intent, sell intent, etc.), and/or any other suitable user-level preference features.

In some embodiments, the training data set 452 includes at least partially labeled training data such that the training data set 452 consists of input training data including at least a first portion of the sequence unit training data 454 representative of initial, intermediate, first, and/or prior states and the user feature training data 456 and target, or output, training data including a portion of the sequence unit training data 454 representative of intermediate, second, and/or final states.

In some embodiments, the training data set 452 includes identifiers for obtaining features from pre-existing feature sets stored in one or more storage locations. For example, in some embodiments, the sequence unit training data 454 and/or the user feature training data 456 can include a set of identifiers. Each of the identifiers can be used to retrieve sequence and/or feature data relevant to and/or associated with the identifiers from a database.

In some embodiments, the training data set 452 includes training data for a specific intent and is configured to generate a sequential prediction model to generate a cross-pollination score 262 for the specific intent. In some embodiments, the received training data set 452 includes training data for a predetermined time period. For example, the training data set 452 can include sequence unit training data 454 limited to a predetermined time period including the last n days, weeks, months, etc. where n is a positive. As another example, in some embodiments, the training data set 452 can be limited to a predetermined time period defined by a set portion of a calendar year, for example, from the last n years for a period of time between a first month and a second month. Although specific embodiments are discussed herein, it will be appreciated that the predetermined time period of the training data set 452 can be selected to be any suitable time period.

At optional step 404, the received training data set 452 is processed and/or normalized by a normalization module 460. For example, in some embodiments, the training data set 452 can be augmented by imputing or estimating missing values of one or more features associated with a sequential state change. In some embodiments, processing of the received training data set 452 includes outlier detection configured to remove data likely to skew training of a state prediction model. In some embodiments, processing of the received training data set 452 includes removing features that have limited value with respect to training of the state prediction model.

At step 406, an iterative training process is executed to train a selected model 462. The selected model 462 can include an untrained (e.g., base) machine learning model, such as a sequential framework model (e.g., SASRec framework or TiSASRec framework), and/or a partially or previously trained model (e.g., a prior version of a trained cross-pollination prediction model, a partially trained model from a prior iteration of a training process, etc.). The training process is configured to iteratively adjust parameters (e.g., hyperparameters) of the selected model 462 to minimize a cost value (e.g., an output of a cost function) for the selected model 462. In some embodiments, the cost value is related to the likelihood of a state transition from a prior state to a next state.

The training process is an iterative process that generates set of revised model parameters 466 during each iteration. The set of revised model parameters 466 can be generated by applying an optimization process 464 to the cost function of the selected model 462. The optimization process 464 can be configured to reduce the cost value (e.g., reduce the output of the cost function) at each step by adjusting one or more parameters during each iteration of the training process.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model 462 has reached a minimum, such as a local minimum and/or a global minimum.

At step 410, a trained cross-pollination prediction model 302 is output and provided for use in an interface generation method, such as the method 200 discussed above with respect to FIGS. 5-6. The trained cross-pollination prediction model 302 is configured to generate a cross-pollination score 262 for at least one intent. At optional step 412, a trained cross-pollination prediction model 302 can be evaluated by an evaluation process 468 to determine the success rate of predicted state generated by the trained cross-pollination prediction model 302. The trained cross-pollination prediction model 302 can be evaluated based on any suitable metrics, such as, for example, impressions for predicted states, interactions with predicted states, scrolling behavior for an interface including predicted states, gross merchandise value (GMV) of products purchased through a predicted state, accuracy of predicted states, weighted or macro precision of predicted states, weighted or macro recall of predicted states, an F or FI score of the state prediction model, normalized discounted cumulative gain (NDCG) of the state prediction model, mean reciprocal rank (MRR) of the predicted states, mean average precision (MAP) score of the state prediction model, and/or any other suitable evaluation metrics. In some embodiments, the trained cross-pollination prediction model 302 is evaluated based on a limited set of evaluation metrics. For example, a trained cross-pollination prediction model 302 can be evaluated based on weighted precision and recall, macro precision and recall, and an F-score. Although specific embodiments are discussed herein, it will be appreciated that any suitable set of evaluation metrics can be used to evaluate a trained cross-pollination prediction model 302.

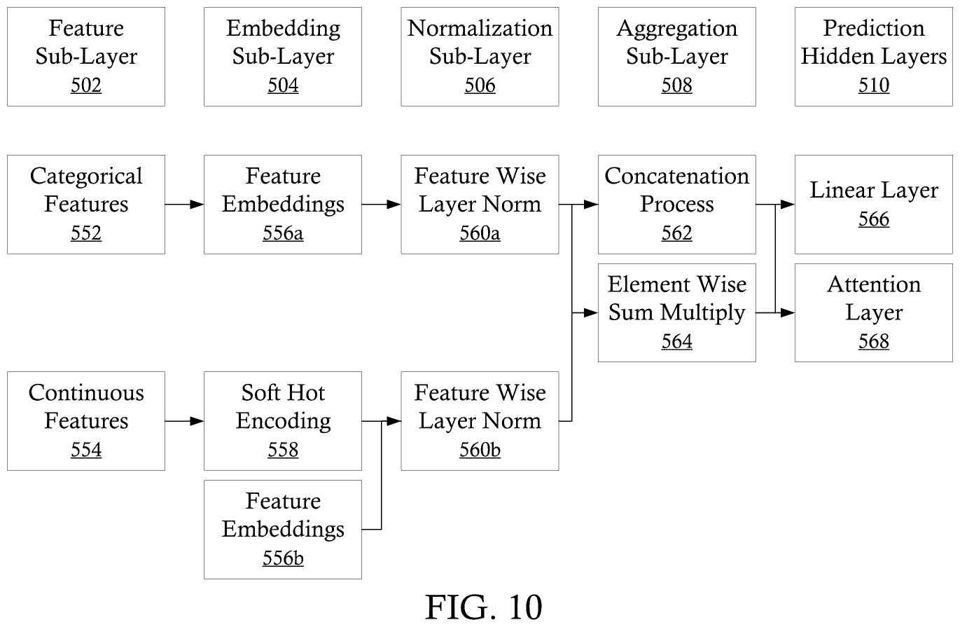

FIG. 10 illustrates a data layer process flow 500 for a trained cross-pollination prediction model, in accordance with some embodiments. A trained cross-pollination prediction model can include a feature layer 502 configured to receive one or more sets of features. The set of features can include, but are not limited to, categorical features 552 and continuous features 554. Each set of features 552, 554 is provided to a feature embedding layer 504 configured to convert a set of features 552, 554 into embeddings 556a, 556b (e.g., a lower-level vector representation of a higher-level input). The embeddings 556a, 556b can be generated using any suitable method, such as, for example, an autoencoder or a predictor.

In some embodiments, an encoding scheme, such as soft hot encoding, one-hot encoding, or soft encoding, can be applied to one or more of the sets of features 552, 554. For example, in some embodiments, a soft hot encoding process 558 is applied to the continuous features 554 to generate encoded input data. The encoding scheme, such as a soft hot encoding scheme, can be configured to convert categorical data elements into numerical data suitable for use by a trained model, such as a trained sequential prediction model. In some embodiments, an applied encoding process converts categorical data into numerical data and subsequently splits the converted data into multiple elements suitable for use by a trained state prediction model.

After the embeddings 556a, 556b and/or the encodings are generated, a normalization layer 506 normalizes the embedding 556a, 556b and/or encoding features to generate feature-wise normalized inputs 560a, 560b. The normalized features are provided to a feature aggregation layer 508 configured to generate aggregated feature inputs by combining two or more of the normalized input features. For example, in various embodiments, the feature aggregation layer 508 can include a concatenation process 562 configured to concatenate two or more normalized features together. As another example, in various embodiments, the feature aggregation layer 508 can include an element wise sum multiply process 564 configured to perform various combinatorial operations, such as an element-based summation and/or multiplication, to generate aggregated feature inputs. Although embodiments are illustrated with aggregated feature inputs, it will be appreciated that a trained state prediction model can be configured to utilize non-aggregated feature inputs in addition to and/or instead of aggregated feature inputs.

The processed (e.g., converted, normalized, and/or aggregated) features are provided to a prediction layer 510. The prediction layer 510 includes a plurality of layers (e.g., hidden layers) configured to generate a likelihood of a transition to a cross-pollinated state based on the input features. In some embodiments, the prediction layer 510 can include multiple sub-layers, such as a linear layer 566 and/or an attention layer 568. In some embodiments, the linear layer 566 includes a constant size input and a constant size output, e.g., sub layer within the linear layer 566 is a linear combination of prior layers. In some embodiments, an attention layer 568 provides arbitrary sizing of inputs and outputs between layers. The output of the linear layer 566 and the attention layer 568 are combined into a cross-pollination score.

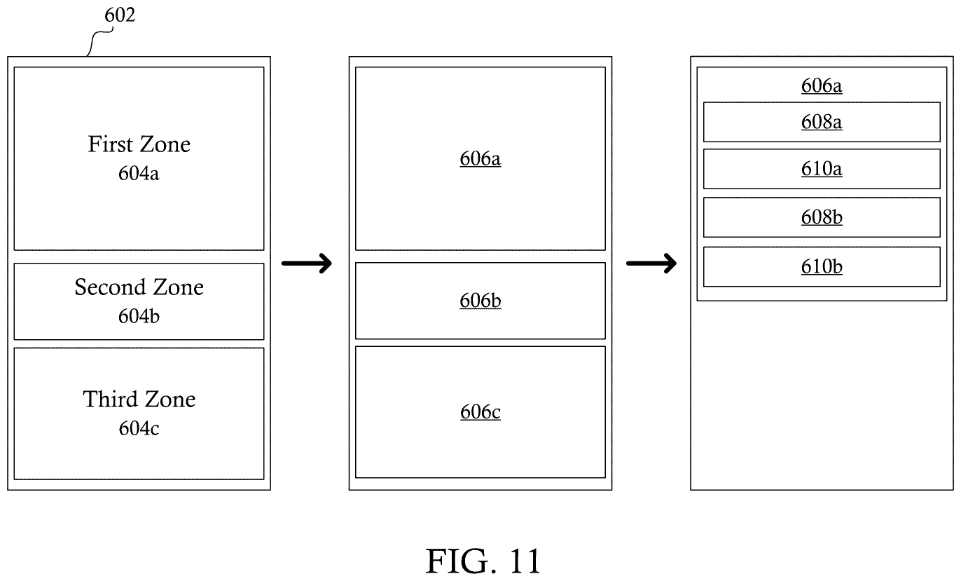

FIG. 11 illustrates an interface generation process flow 600 including insertion of cross-pollinated interface elements, in accordance with some embodiments. In some embodiments, the interface generation process flow 600 is configured to perform “whole page” personalization. For example, in some embodiments, a default template 602 is selected based on an initial intent, e.g., a grocery intent, the default template 602 include a plurality of zones 604a-604c, each configured to receive content containers 606a-606c based on the initial intent. Content containers 606a-606c can include any suitable containers for displaying content and/or receiving user interactions, such as, for example, carousels, banners, input forms, interactive elements, etc.

After identifying content containers 606a-606c for each zone 604a-604c, an interface generation engine selects first intent content elements 608a-608b for insertion into at least one of the content containers 606a-606c. The first intent content elements 608a-608b include interface elements, such as items, buttons, etc., that are related to the first intent. In addition, the interface generation engine receives a cross-pollination score for at least one second intent. Based on the cross-pollination score, the interface generation engine selects cross-pollinated content elements 610a-610b for insertion into the at least one of the content containers 606a-606c. In some embodiments, the cross-pollinated content elements 610a-610b are related to the at least one second intent.

In some embodiments, the number of cross-pollinated content elements 610a-610b is determined by comparing the received cross-pollination score to one or more thresholds. The cross-pollinated content elements 610a-610b can be inserted in addition and/or alternatively to the first intent content elements 608a-608b. Although embodiments are illustrated with two cross-pollinated content elements 610a-610b, it will be appreciated that the interface generation engine can be configured to insert any number of cross-pollinated content elements 610a-610b based on the cross-pollination score and/or additional parameters, such as the size of the interface, the first intent, etc.

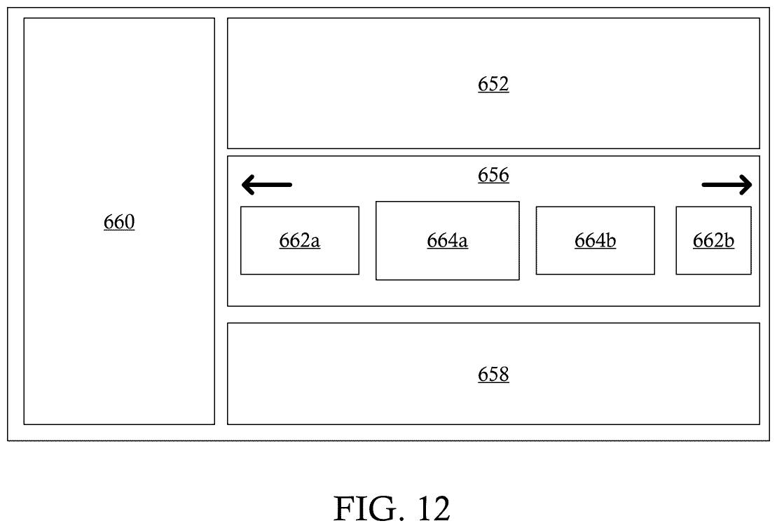

FIG. 12 illustrates an interface 650 including a carousel 652 having cross-pollinated items 656a-656b, in accordance with some embodiments. The interface 650 can be generated according to any of the interface generation methods disclosed herein. As illustrated in FIG. 12, the interface includes header section 654, a content container, such as a carousel 656, a footer section 658, and a sidebar 660. Although specific elements are illustrated on the interface 650, it will be appreciated that any suitable interface elements or content containers can be included. The carousel 656 includes first intent items 662a-662b selected according to a first intent and cross-pollinated items 664a-664b selected according to a second, cross-pollinated, intent. Although embodiments are illustrated including a carousel 656, it will be appreciated that any suitable content container can be include within an interface 650 and can include both first intent items 662a-662b and cross-pollinated items 664a-664b.

In some embodiments, the number of cross-pollinated items 664a-664b is determined by comparing the received cross-pollination score to one or more thresholds. The cross-pollinated items 664a-664b can be inserted in addition and/or alternatively to the first intent items 662a-662b. Although embodiments are illustrated with two cross-pollinated items 664a-664b, it will be appreciated that the interface generation engine can be configured to insert any number of cross-pollinated items 664a-664b based on the cross-pollination score and/or additional parameters, such as the size of the interface, the first intent, etc.

Although the subject matter has been described in terms of exemplary embodiments, it is not limited thereto. Rather, the appended claims should be construed broadly, to include other variants and embodiments, which can be made by those skilled in the art.

What is claimed is:

1. A system comprising:
a non-transitory memory;
a communications interface, configured to receive a request for an interface for a first intent, wherein the request includes a user identifier that is stored in the non-transitory memory;
an interface generation engine configured to:
generate an interface including a set of first items associated with the first intent;
generate a set of cross-pollinated items associated with a second intent, wherein the set of cross-pollinated items are selected based on a cross-pollination score; and
insert the set of cross-pollinated items into the interface; and
transmit the interface to a user device associated with the user identifier; and
a cross-pollination engine configured to:
receive a set of features associated with the user identifier and the first intent; and
generate the cross-pollination score using a trained sequential prediction model, wherein the trained sequential prediction model is configured to receive the set of features associated with the user identifier and output the cross-pollination score, wherein the cross-pollination score represents a likelihood of a user associated with the user identifier interacting with at least one cross-pollinated item.

2. The system of claim 1, wherein the trained sequential prediction model comprises one of a SASRec model or a TiSASRec model.

3. The system of claim 1, wherein the interface generation engine is configured to determine a number of elements in the set of cross-pollinated items by comparing the cross-pollination score to at least one threshold value.

4. The system of claim 3, wherein the set of cross-pollinated items includes a first number of items when the cross-pollination score is below the at least one threshold value, and wherein the set of cross-pollinated items includes a second number of items when the cross-pollination score is equal to or above the at least one threshold value.

5. The system of claim 1, wherein the interface generation engine is configured to:
obtain an interface template;
select at least one container for insertion into the interface template; and
insert the set of first items and the set of cross-pollinated items into the at least one container.

6. The system of claim 1, wherein the interface generation engine is configured to receive, via the communications interface, interaction data for the generated interface.

7. The system of claim 1, wherein the trained sequential prediction model comprises an aggregation layer including a concatenation process and an element wise sum multiply process.

8. The system of claim 1, wherein the trained sequential prediction model comprises a linear layer and an attention layer.

9. A computer-implemented method, comprising:
receiving, via a communications interface, a request for an interface for a first intent, wherein the request includes a user identifier that is stored in a non-transitory memory;
generating, by an interface generation engine, an interface including a set of first items associated with the first intent;
receiving, by a cross-pollination engine, a set of features associated with the user identifier and the first intent;
generating, by the cross-pollination engine, a cross-pollination score using a trained sequential prediction model, wherein the trained sequential prediction model is configured to receive the set of features associated with the user identifier and output the cross-pollination score, wherein the cross-pollination score represents a likelihood of a user associated with the user identifier interacting with at least one cross-pollinated item;
inserting, by the interface generation engine, a set of cross-pollinated items into the interface, wherein the cross-pollinated items are associated with a second intent, wherein the set of cross-pollinated items are selected based on the cross-pollination score; and
transmitting, via the communications interface, the interface to a user device associated with the user identifier.

10. The method of claim 9, wherein the trained sequential prediction model comprises one of a SASRec model or a TiSASRec model.

11. The method of claim 9, comprising determining, by the interface generation engine, a number of elements in the set of cross-pollinated items by comparing the cross-pollination score to at least one threshold value.

12. The method of claim 11, wherein the set of cross-pollinated items includes a first number of items when the cross-pollination score is below the at least one threshold value, and wherein the set of cross-pollinated items includes a second number of items when the cross-pollination score is equal to or above the at least one threshold value.

13. The method of claim 9, comprising
obtaining, by the interface generation engine, an interface template;
selecting, by the interface generation engine, at least one container for insertion into the interface template; and
inserting, by the interface generation engine, the set of first items and the set of cross-pollinated items into the at least one container.

14. The method of claim 9, wherein the interface generation engine is configured to receive, via the communications interface, interaction data for the generated interface.

15. The method of claim 9, wherein the trained sequential prediction model comprises an aggregation layer including a concatenation process and an element wise sum multiply process.

16. The method of claim 9, wherein the trained sequential prediction model comprises a linear layer and an attention layer.

17. A method of training a sequential prediction model, comprising:
receiving a set of training data including a plurality of feature sets associated with a plurality of user identifiers, wherein each feature set in the plurality of feature sets is associated with prior interactions between a user associated with the user identifier and a network interface;
iteratively modifying one or more parameters of a sequential prediction model to minimize a predetermined cost function; and
outputting a trained sequence prediction model configured to receive a current a plurality of features related to a user identifier and generate a cross-pollination score.

18. The method of training the sequential prediction model of claim 17, wherein the sequential prediction model comprises a SASRec model or a TiSASRec model.

19. The method of training the sequential prediction model of claim 17, wherein the set of features includes one or more intents associated with the user identifier.

20. The method of training the sequential prediction model of claim 17, wherein the cross-pollination score represents a likelihood of a user interacting with a cross-pollinated item.
